(19) United States
(12) Patent Application Publication
(10) Pub. No.: US 2007/0147948 A1
(43) Pub. Date: Jun. 28, 2007

(54) Solid paste dispenser

(75) Inventors: Yasuo Murakoshi, Saitama (JP); Hideo Shimizu, Saitama (JP)

Correspondence Address: EDWARDS ANGELL PALMER & DODGE LLP, P.O. BOX 55874, BOSTON, MA, 02205, US

(73) Assignee: Tombow Pencil Co. Ltd., Tokyo (JP)

(21) Appl. No.: 11/638,294

(22) Filed: Dec. 13, 2006

(30) Foreign Application Priority Data
Dec. 27, 2005 (JP) JP2005-376183

(51) Int. Cl. B43K 5/06; B43K 21/08

(52) U.S. Cl. 401/175; 401/75

(57) ABSTRACT

There is provided a solid paste dispenser which makes clear whether or not solid paste for replacement is retained on the side of the solid paste dispenser during replacing work of the solid paste so as not to cause a trouble that solid paste is crushed erroneously. The solid paste dispenser includes a slider 7 caused to ascend and descend within a main body cylinder 2 by rotating a tail wheel 3 mounted to one end of the main body cylinder 2 to rotate a screw rod 5 formed integrally with the tail wheel 3 within the main body cylinder 2, such that a front end 4a of a solid paste 4 mounted to the slider 7 is protruded from and retracted into the main body cylinder 2. The solid paste 4 is indirectly mounted to the slider 7 by retaining a rear end of the solid paste 4 in a solid paste receiving member 8 engaging the slider 7 in detachable manner.

### BACKGROUND OF THE INVENTION

1. Field of the Invention

The present invention relates to a solid paste dispenser which facilitates replacement of solid paste.

2. Description of the Related Art

As to prior methods of replacing solid paste in a solid paste dispenser, reference can be made to JP-A-2003-231572, Japanese Utility Model Registration No. 3080106, etc.

JP-A-2003-231572, as shown in FIG. 17, suggests a method of replacing solid paste in a solid paste dispenser which includes a slider 05 caused to ascend and descend within a main body cylinder 01 by threaded engagement with a screw rod 03 formed integrally with a tail wheel 02 and by guidance by a guide ridge 04 axially provided on an inner peripheral surface of the main body cylinder 01, by rotating a tail wheel 02 mounted to one end of the main body cylinder 01 to rotate the screw rod 03 within the main body cylinder 01, and which is adapted so that a front end of columnar solid paste mounted to the slider 05 can be protruded from and retracted into the main body cylinder. In this replacing method, after the slider 05 which has retained the worn solid paste is detached from the screw rod 03, a rear end opening 07a of a cartridge case 07 which accommodates solid paste 06 for replacement which is retained by another slider 05 is fitted on a front end 01a of the main body cylinder 01, a threaded groove 05a provided in an axial position of the slider 05 is engaged in threaded manner with the screw rod 03, and the rear value 02 is rotated such that the solid paste 06 for replacement retained in the slider 05 is accommodated within the main body cylinder 01.

However, in this replacing method, it is not necessarily clear whether or not the slider 05 which retains the solid paste 06 for replacement and the screw rod 03 are in positions where they are to be engaged with each other, during replacing work. For this reason, there is a case that the cartridge case 07 is strongly pushed against the main body cylinder 01, and consequently the solid paste 06 for replacement may be crushed. This causes a consumer inconvenience in smoothly using the replaced solid paste 06 for replacement. When the degree of the crushing is greater, there is a fear that the solid paste cannot be used. Japanese Utility Model Registration No. 3080106 also has the same problem.

### SUMMARY OF THE INVENTION

The present invention has been made in consideration of the above problem.

It is therefore an object of the present invention to provide an improved solid paste dispenser. In particular it is an object of the present invention to provide a solid paste dispenser, which makes clear whether or not solid paste for replacement is retained on the side of the solid paste dispenser during replacing work so as not to cause any trouble in that solid paste may be crushed by erroneously strongly pushing a cartridge case accommodating the solid paste against a cylinder in the solid paste dispenser.

These objects according to one aspect of the invention are obtained by:

A solid paste dispenser comprising a slider which is in threaded engagement with a screw rod formed integrally with a tail wheel mounted to an end of a main body cylinder for rotating the screw rod within the main body cylinder for ascending and descending said slider within the main body cylinder by rotating the tail wheel, a guide ridge axially provided on an inner peripheral surface of the main body cylinder for guiding the slider, and a columnar solid paste mounted to the slider for protruding a front end of the solid paste from the main body cylinder and retracting it into the main body cylinder,

wherein the solid paste is indirectly mounted to the slider by retaining a rear end of the solid paste in a solid paste receiving member, said solid paste receiving member engaging said slider in detachable manner.

According to an embodiment of the invention a locking claw is provided in any one of both the solid paste receiving member and the slider, and an engaging part is provided in the other one, at least one of the locking claw and the engaging part is adapted to be elastically deformed, and the elastic deformation is utilized so as to detachably engage the solid paste receiving member with the slider.

According to another embodiment of the invention a guide part for rotating the solid paste receiving member relative to the slider is provided in order to lock the locking claw provided in any one of the solid paste receiving member and the slider to the engaging part provided in the other one.

Still in another embodiment of the invention the slider is formed from a guide cylinder having a part to be screwed to the screw rod at an inner peripheral surface thereof, and an engaging part provided at a rear end of the guide cylinder, and an outer peripheral surface of the guide cylinder is provided with a rearward converging guide groove, and the solid paste receiving member is provided with a guide locking piece, the guide groove and the guide locking piece constitute the guide part, and the guide locking piece is guided by the guide groove to rotate the solid paste receiving member relative to the slider so that the locking piece provided in the solid paste receiving member is locked to the engaging part provided in the slider.

According to another embodiment of the invention the slider is formed from a guide cylinder having a part to be screwed to the screw rod at an inner peripheral surface thereof, and having a rearward converging guide groove at an outer peripheral surface thereof, and an outer cylinder coaxially provided at a rear end of the guide cylinder, having a larger diameter than the guide cylinder, and having an engaging part, and the solid paste receiving member is formed from a guided cylinder having a solid paste retaining part at a front end thereof, fitted on the guide cylinder in the slider, and having a locking part, and an inner peripheral surface of the guided cylinder is provided with a guide locking piece such that the guide locking piece is guided by the guide groove of the slider.

In another embodiment of the invention a rear end of the rearward converging guide groove provided at the outer peripheral surface of the guide cylinder in the slider is provided with an axial auxiliary guide groove continuously with the guide groove.

In another aspect of the invention there is provided:

A solid paste dispenser comprising a slider which is in threaded engagement with a screw rod formed integrally with a tail wheel mounted to an end of a main body cylinder for rotating the screw rod within the main body cylinder for ascending and descending said slider within the main body cylinder by rotating the tail wheel, a guide ridge axially provided on an inner peripheral surface of the main body cylinder for guiding the slider, and a columnar solid paste mounted to the slider for protruding a front end of the solid paste from the main body cylinder and retracting it into the main body cylinder,

wherein the solid paste is indirectly mounted to the slider by retaining a rear end of the solid paste in a solid paste receiving member, said solid paste receiving member engaging said slider in detachable manner, and

wherein, a positioning means is provided for determining the rotational position of the solid paste receiving member with respect to the slider when the solid paste receiving member is engaged with the slider, said positioning means comprising a protruding fitting part in any one of facing surfaces between the solid paste receiving member and the slider, and a concave fitting part in the other one such that a fitting between the protruding fitting part and the concave fitting part can visually be recognized from outside, thereby allowing rotational positioning by virtue of the fitting.

According to an embodiment of this aspect of the invention a locking claw is provided in any one of both the solid paste receiving member and the slider, and an engaging part is provided in the other one, at least one of the locking claw and the engaging part is adapted to be elastically deformed, and the elastic deformation is utilized so as to detachably engage the solid paste receiving member with the slider.

According to another embodiment, the solid paste receiving member is formed by providing an axial paste receiving cylinder within which an insertion hole for the screw rod is formed, in the center of a paste receiving base so as to protrude forward and rearward, providing a solid paste retaining part at a front part of the paste receiving cylinder, forming a prismatic fitting part at a rear part of the paste receiving cylinder, and providing a locking piece having a locking claw at a rear end thereof, on a rear surface of the paste receiving base so as to protrude therefrom, and the slider is formed by providing an axial slider cylinder having a part to be screwed with the screw rod on an inner peripheral surface of a rear part thereof and having a concave fitter part at a front part thereof, in the center of a base of a slider so as to protrude forward, and providing an engaging part to be locked to the locking claw, in the slider base.

Still in another embodiment the solid paste receiving member is formed by providing a paste receiving cylinder within which an insertion hole for the screw rod is formed, in the center of a paste receiving base so as to protrude forward and rearward, providing a solid paste retaining part at a front part of the paste receiving cylinder, forming a prismatic fitting part at a rear part of the paste receiving cylinder, forming a rear surface of the paste receiving base in the shape of a truncated cone whose diameter is reduced rearward, and providing a peripheral annular groove engaging part on a lateral peripheral surface of the truncate cone, and the slider is formed by proving a slider cylinder having a concave fitted part, in a front center of a slider base having a part to be screwed with the screw rod in the center thereof, and providing the slider base with a forward locking piece having a locking claw to be locked to the annular groove engaging part at a front end thereof.

Finally in an embodiment of the invention an outer peripheral surface of a front part of the paste receiving cylinder is provided with a flange-like retaining part for retaining the solid paste.

According to the invention, the following effects can be exhibited.

Since the replacing work of solid paste is performed by detachably engaging the solid paste receiving member in which solid paste for replacement is retained in advance with the slider without replacing the slider, it is unnecessary to perform troublesome work that the slider in which solid paste for replacement is retained is engaged in threaded manner with the screw rod like the replacing work in the related art, and there is no fear that, as the cartridge case which accommodates solid paste for replacement is strongly pushed against the main body cylinder in the solid paste dispenser, the solid paste may be crushed.

Since the locking claw is locked to the engaging part by elastic deformation, the locking is performed positively, and whether or not the solid paste receiving member which retains solid paste for replacement is engaged with the slider can be clearly recognized not only visually, but also aurally by a flip sound which is generated when the locking claw is locked to the engaging part by elastic deformation.

Since the rotational position of the solid paste receiving member with respect to the slider is automatically guided by the guide part such that the locking claw in any one of the solid paste receiving member and the slider is well locked to the engaging part provided in the other one, an operator can perform the replacing work smoothly without focusing his/her attention to the rotational position of the solid paste receiving member.

Since the guide locking piece in the solid paste receiving member is guided by the guide groove provided in the outer peripheral surface of the guide cylinder in the slider by moving the solid paste receiving member rearward relative to the slider, a proper rotational position of the solid paste receiving member with respect to the slider is automatically adjusted, and the locking part of the solid paste receiving member is automatically locked to the engaging part provided at the rear end of the slider.

Since the guide groove is provided in the outer peripheral surface of the guide cylinder in the slider, and the guide locking piece is provided in the inner peripheral surface of the guided cylinder of the solid paste receiving member, the guide locking piece is guided by the guide groove simply by fitting the guided cylinder on the guide cylinder of the slider, and thereby the rotational position of the solid paste receiving member with respect to the slider is automatically adjusted. Therefore, the replacing work can be performed smoothly.

Since the locking piece is guided by the auxiliary guide groove and the locking piece is positively locked to the engaging part, simply by pushing in the solid paste receiving member rearward without interruption after the rotational position of the solid paste receiving member with respect to the slider is adjusted automatically, the replacing work can be performed smoothly and efficiently.

Since the replacing work of solid paste is performed by detachably engaging the solid paste receiving member in which solid paste for replacement is retained in advance with the slider without replacing the slider, it is unnecessary to perform troublesome work that the slider in which solid paste for replacement is retained is threadedly engaged with the screw rod like the replacing work in the related art, and there is no fear that, as the cartridge case which accommodates solid paste for replacement is strongly pushed against the main body cylinder in the solid paste dispenser, the solid paste may be crushed.

In particular, when the solid paste receiving member is engaged with the slider, proper rotational positioning of the solid paste receiving member with respect to the slider is easily performed while the engagement is easily recognized from outside. Thus, the replacing work of solid paste can be performed efficiently without erroneously crushing the solid paste.

Since the locking claw is locked to the engaging part by elastic deformation, the locking is performed positively, and whether or not the solid paste receiving member which retains solid paste for replacement is engaged with the slider can be clearly recognized not only visually, but also aurally by a flip sound which is generated when the locking claw is locked to the engaging part by elastic deformation.

During the replacing work of solid paste, a proper rotational position of the solid paste receiving member with respect to the slider is adjusted simply by fitting the prismatic fitting part into the concave fitted part while the fitting is recognized visually from outside. Next, by moving the solid paste receiving member rearward relative to the slider as it is, the locking claw of the solid paste receiving member is automatically locked to the engaging part of the slider, and the solid paste is mounted to the slider by means of the solid paste receiving member.

During the replacing work of solid paste, a proper rotational position of the solid paste receiving member with respect to the slider is adjusted simply by fitting the prismatic fitting part into the concave fitted part while the fitting is recognized visually from outside. Next, by moving the solid paste receiving member rearward relative to the slider as it is, the locking claw of the slider is automatically locked to the annular groove engaging part of the solid paste receiving member, and the solid paste is mounted to the slider by means of the solid paste receiving member.

The solid paste is positively retained in the solid paste receiving member, and even if a front end of the solid paste is repeatedly protruded from and retracted into the front end opening of the main body cylinder in the solid paste dispenser, the solid paste can be prevented from falling out of the solid paste receiving member.

The accompanying drawings which are incorporated in and constitute part of the present specification, are included to illustrate and provide for a further understanding of the invention.

### BRIEF DESCRIPTION OF THE DRAWINGS

FIG. 1 is a central longitudinal sectional view of a solid paste dispenser according to a first embodiment of the invention having a solid paste accommodated therein;

FIG. 2 is a central longitudinal sectional view of a cartridge case accommodating solid paste for replacement in the solid paste dispenser according to the first embodiment of the invention, with parts broken away;

FIG. 3 is an enlarged perspective fragmentary view of the main parts in a status of the solid paste dispenser according to the first embodiment of the invention when replacing work of solid paste is performed;

FIG. 4 is an enlarged fragmentary front view of the main parts in another status of the solid paste dispenser according to the first embodiment of the invention for explaining the replacing work;

FIG. 5 is an enlarged fragmentary front view of the main parts in still another status of the main parts of the solid paste dispenser according to the first embodiment of the invention for explaining the replacing work;

FIG. 6 is an enlarged longitudinal sectional fragmentary view of the main parts of the solid paste dispenser according to the first embodiment of the invention for explaining the replacing work;

FIG. 7 is a central longitudinal sectional view of a solid paste dispenser according to a second embodiment of the invention showing a status having a solid paste accommodated therein, with parts broken away;

FIG. 8 is a central longitudinal sectional view of a cartridge case accommodating solid paste for replacement in the second embodiment of the invention, with parts broken away;

FIG. 9 is an enlarged perspective fragmentary view of the main parts of the solid paste dispenser according to the second embodiment of the invention when replacing work of solid paste is performed;

FIG. 10 is an enlarged longitudinal sectional fragmentary view of the main parts in a status of the solid paste dispenser according to the second embodiment of the invention for explaining the replacing work;

FIG. 11 is an enlarged longitudinal sectional fragmentary view of main parts in another status of the solid paste dispenser according to the second embodiment of the invention for explaining the replacing work;

FIG. 12 is a central longitudinal sectional view of a solid paste dispenser according a third embodiment of the invention, with parts thereof broken away showing a state where solid paste is accommodated therein;

FIG. 13 is a central longitudinal sectional view, with parts broken away, of a cartridge case accommodating solid paste for replacement in the third embodiment of the invention;

FIG. 14 is an enlarged perspective fragmentary view of the main parts of the solid paste dispenser according the third embodiment of the invention in a status during replacing work of solid paste;

FIG. 15 is an enlarged longitudinal sectional fragmentary view of the main parts in another status of the solid paste dispenser according the third embodiment of the invention for explaining the replacing work;

FIG. 16 is an enlarged longitudinal sectional fragmentary view of the main parts in still another status of the solid paste dispenser according the third embodiment for explaining the replacing work; and

FIG. 17 is a central longitudinal sectional view of a conventional solid paste dispenser for explaining the replacing work of solid paste.

### DESCRIPTION OF THE PREFERRED EMBODIMENTS

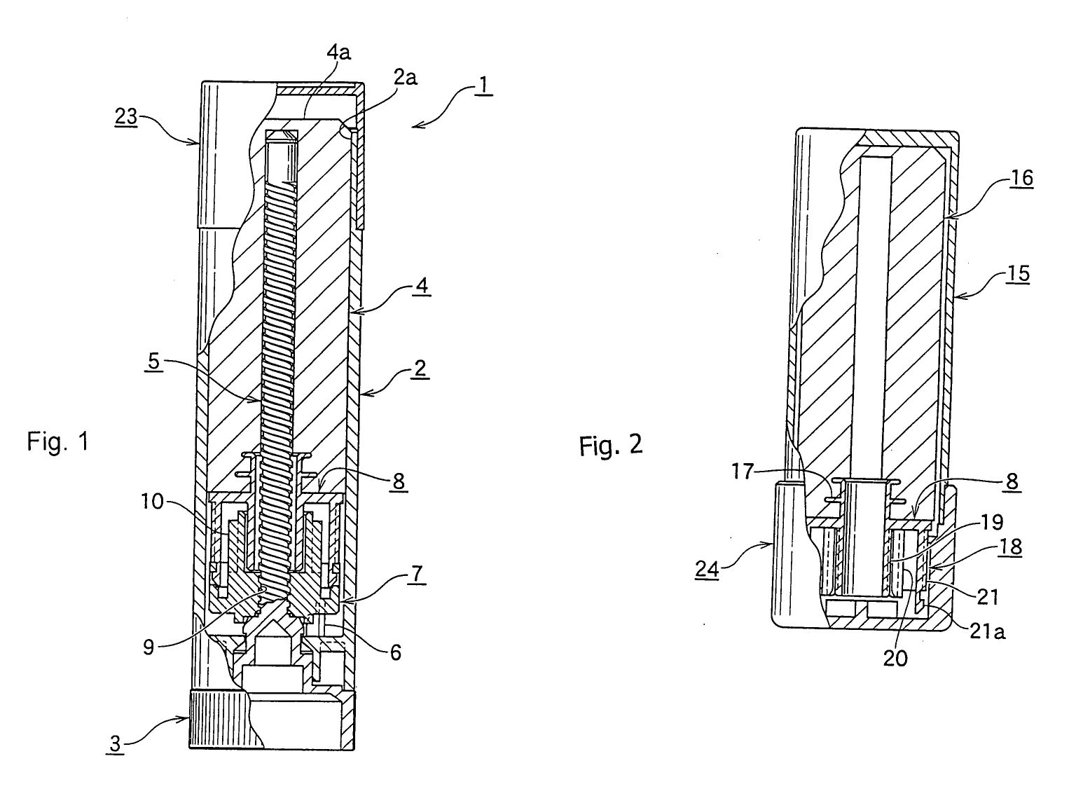

FIGS. 1 to 6 are views relating to a solid paste dispenser according to a first embodiment of the invention.

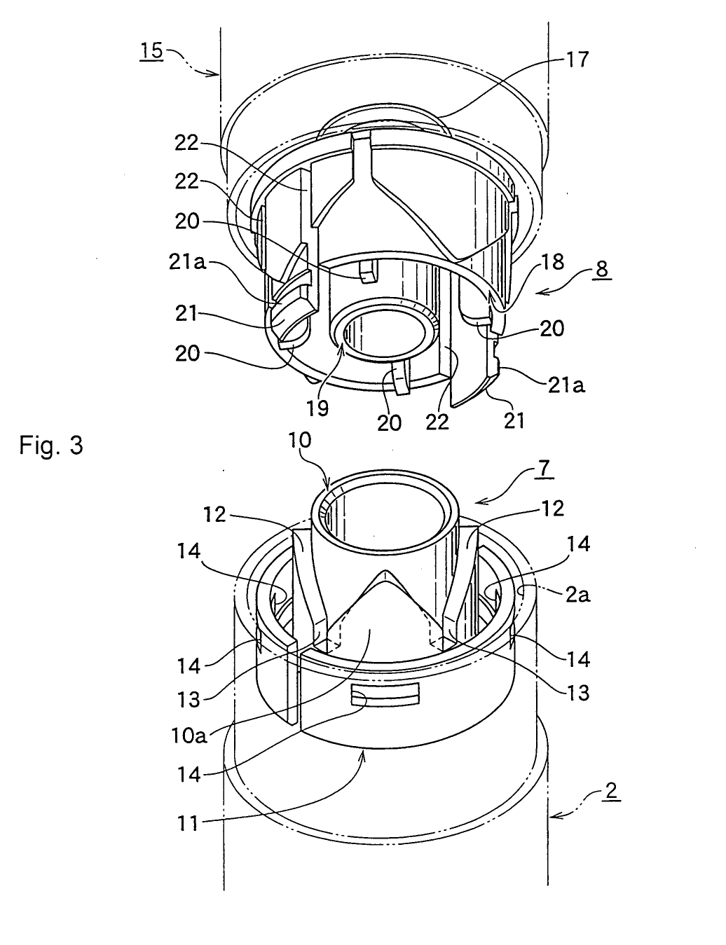

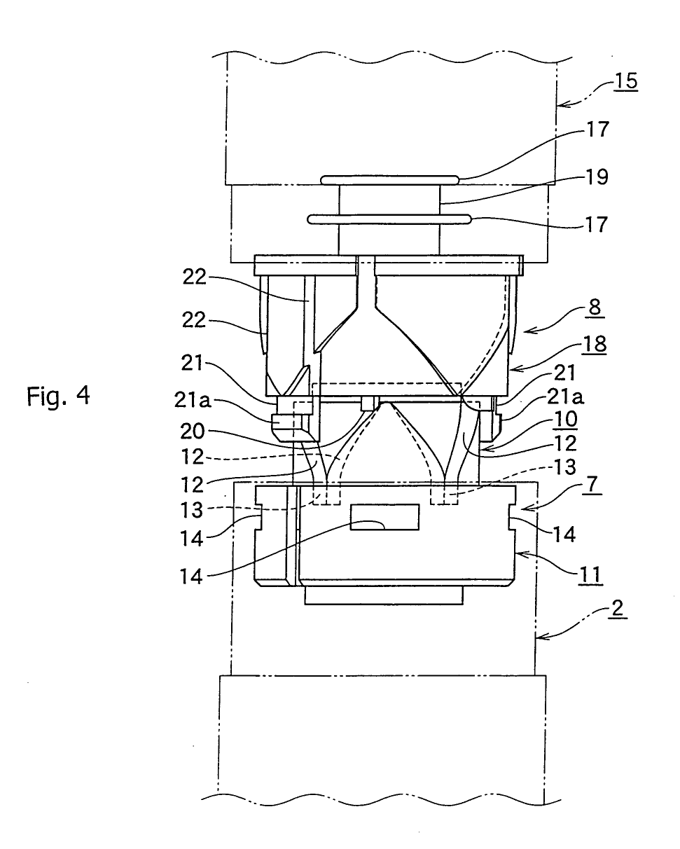

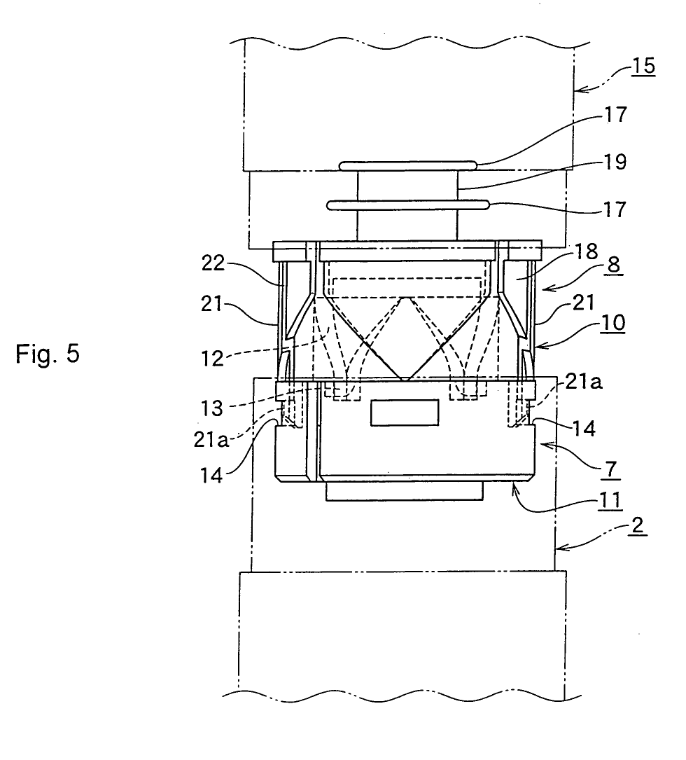

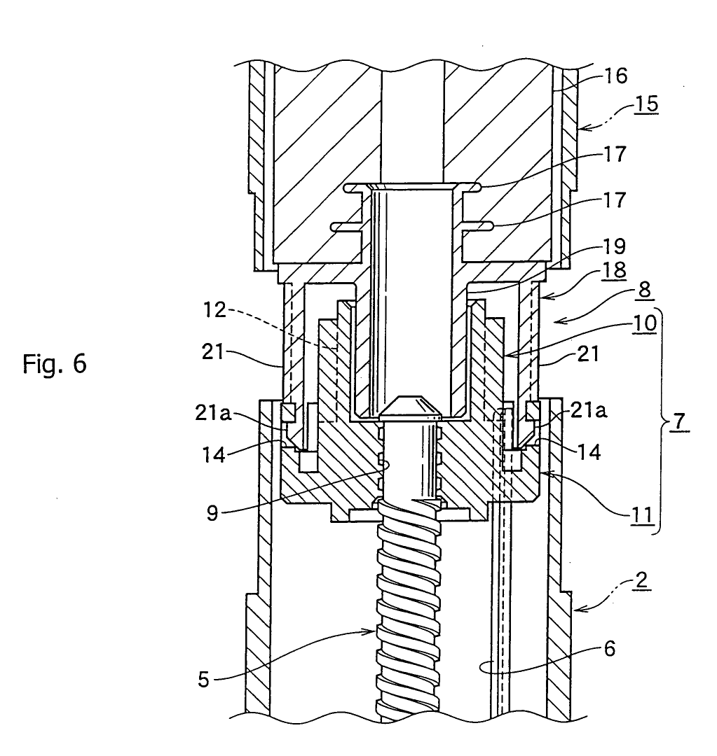

FIG. 1 is a central longitudinal sectional view showing a state where solid paste is accommodated in the solid paste dispenser of the invention, FIG. 2 is a central longitudinal sectional view showing a cartridge case which accommodates solid paste for replacement, with a part thereof broken away, FIG. 3 is an enlarged perspective view of main parts when replacing work of solid paste is performed, FIGS. 4 and 5 are enlarged front views of main parts for explaining the replacing work, and FIG. 6 is an enlarged longitudinal sectional view of main parts for explaining the replacing work.

The solid paste dispenser 1, similarly to a publicly-known solid paste dispenser, is adapted to protrude a front end 4a of solid paste 4 from a front end opening 2a and retract the front end into the front end opening by the rotation of a tail wheel 3 which is mounted to one end of a main body cylinder 2.

A screw rod 5 is integrally formed with the tail wheel 3, and a slider 7 is adapted to ascend and descend within the main body cylinder 2 with the rotation of the tail wheel 3 by threaded engagement with the screw rod 5 and by guidance by a guide ridge 6 which is axially provided on an inner peripheral surface of the main body cylinder 2.

A solid paste receiving member 8 which retains the solid paste 4 is detachably engaged with the slider 7. By rotating the tail wheel 3, the front end 4a of the solid paste 4 can be protruded from and retracted into the front end opening 2a of the main body cylinder 2. Similarly to the slider 7, the solid paste receiving member 8 is also provided with an engaging groove which is engaged with the guide ridge 6.

As shown in FIGS. 3 and 6, the slider 7 is formed by a guide cylinder 10 having a part 9 to be screwed to the screw rod 5 at its inner peripheral surface, and an outer cylinder 11 coaxially provided at a rear end of the guide cylinder 10 and having a larger diameter than the guide cylinder 10.

An outer peripheral surface 10a of the guide cylinder 10 is provided with guide grooves 12 having a substantially inverted triangular shape in front view, which converges rearward, and a rear end of the guide grooves 12 is provided with an axial auxiliary guide grooves 13 continuously with the rear end.

A peripheral wall 11a of the outer cylinder 11 is provided with four engaging holes 14 as engaging parts which are arranged at regular intervals in a peripheral direction.

As shown in FIGS. 2, 3 and 6, solid paste 16 for replacement accommodated in a cartridge case 15 is retained by the solid paste receiving member 8. The solid paste receiving member 8 is composed of a guided cylinder 18 having a solid paste retaining part 17 at a front end thereof. An inner cylinder 19 is coaxially provided in the guided cylinder 18, and two-stage flange-like parts are provided at an outer periphery of the portion of the inner cylinder 19 which protrudes further forward than the guided cylinder 18. These flange-like parts form the solid paste retaining part 17.

An inner peripheral surface of the guided cylinder 18 is provided with four axial guide locking pieces 20 which are arranged at regular intervals in the peripheral direction.

The portions of the guided cylinder 18 corresponding to diametrical opposite ends of the cylinder are provided with locking pieces 21, respectively, which extend rearward (downward in FIG. 3) and which have outward locking claws 21a annexed to rear ends thereof. Slits 22 are provided on the right and left sides of the locking piece 21, whereby the locking piece 21 can be deformed in the radial direction.

Next, the procedure when replacing work is performed by mounting the solid paste 16 for replacement to the slider 7 will be described.

First, as shown in FIG. 3, a cap 23 (refer to FIG. 1) of the main body cylinder 2 is detached, and the tail wheel 3 is rotated to partially protrude the slider 7 from the front end opening 2a of the main body cylinder 2.

Next, a cap 24 of the cartridge case 15 which accommodates the solid paste 16 for replacement shown in FIG. 2 is detached. Then, as shown in FIG. 3, the solid paste receiving member 8 is caused to approach the slider 7 with the cartridge case 15 upside down, and as shown in FIG. 4, the guided cylinder 18 in the solid paste receiving member 8 is fitted on the guide cylinder 10 in the slider 7 and is pushed in. Thereby, the guide locking pieces 20 provided at the inner peripheral surface of the guided cylinder 18 is abutted on and guided by the rearward converging guide grooves 12 which are provided at the outer peripheral surface of the guide cylinder 10, and then the solid paste receiving member 8 rotates relative to the slider 7, thereby automatically adjusting a proper rotational position of the solid paste receiving member 8.

As such, the guide locking pieces 20 in the solid paste receiving member 8 and the guide grooves 12 in the slider 7 function as guide parts for adjusting a proper rotational position of the solid paste receiving member 8 with respect to the slider 7 in order to lock the locking claws 21a of the locking pieces 21 provided in solid paste receiving member 8 to the engaging holes 14 provided in the slider 7.

Next, the solid paste receiving member 8 is further pushed in, and moved rearward relative to the slider 7, whereby the guide locking pieces 20 are guided by the auxiliary guide grooves 13 which are axially provided continuously with the guide grooves 12, and the locking claws 21a of locking pieces 21 in the solid paste receiving member 8 are locked to the engaging holes 14.

Since the locking pieces 21 is adapted to be capable of being deformed in radial direction of the guided cylinder 18, the locking claws 21a of the locking pieces 21 are positively locked to the engaging holes 14, whereby the solid paste 16 for replacement is indirectly mounted to the slider 7 by means of the solid paste receiving member 8.

Next, the tail wheel 3 is rotated to draw the solid paste receiving member 8 retaining the solid paste 16 for replacement along with the slider 7 into the main body cylinder 2, whereby the replacing work of the solid paste 16 for replacement is completed.

When the replaced solid paste 4 is worn, and it is replaced with a new solid paste 16 for replacement, the tail wheel 3 is rotated to protrude the solid paste receiving member 8 from the front end opening 2a of the main body cylinder 2, and then the right and left locking pieces 21 of the solid paste receiving member 8 are pushed and elastically deformed toward the inside from the outside. Thereby, the locking between the locking claws 21a of the locking pieces 21 and the engaging holes 14 are released, so that the solid paste receiving member 8 can be easily detached from the slider 7.

The worn solid paste 4 may be disposed along with the solid paste receiving member 8, or may be disposed after being separated from the solid paste receiving member 8.

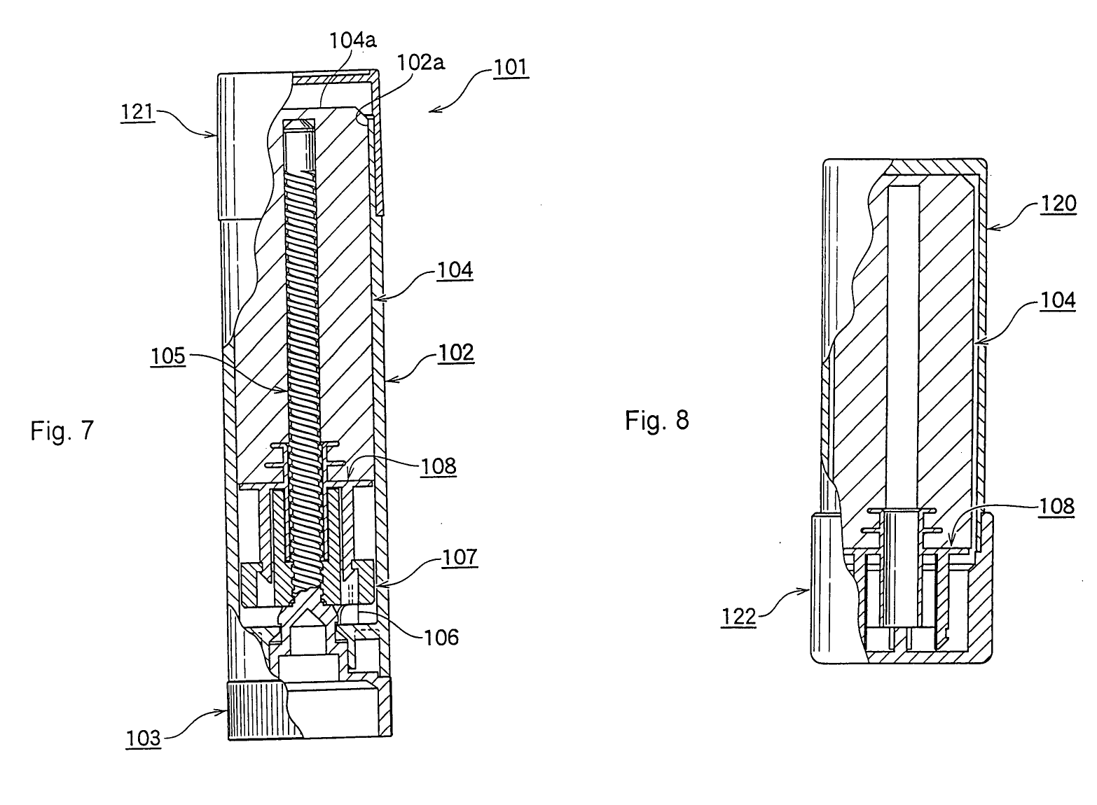

FIGS. 7 to 11 are views relating to a solid paste dispenser 101 of a second embodiment of the invention.

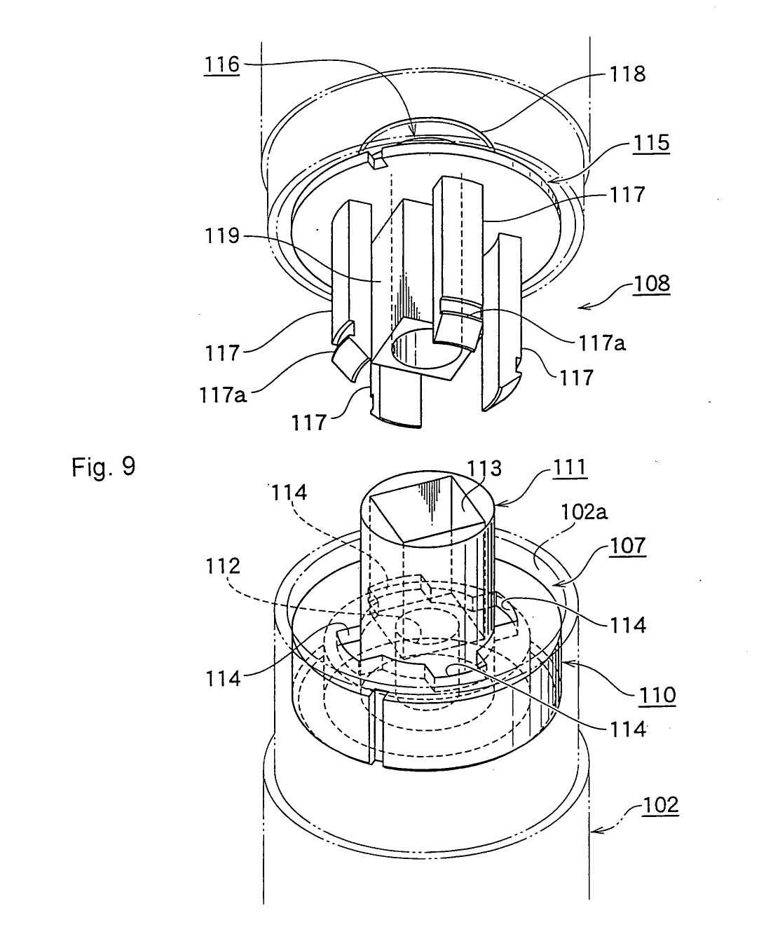

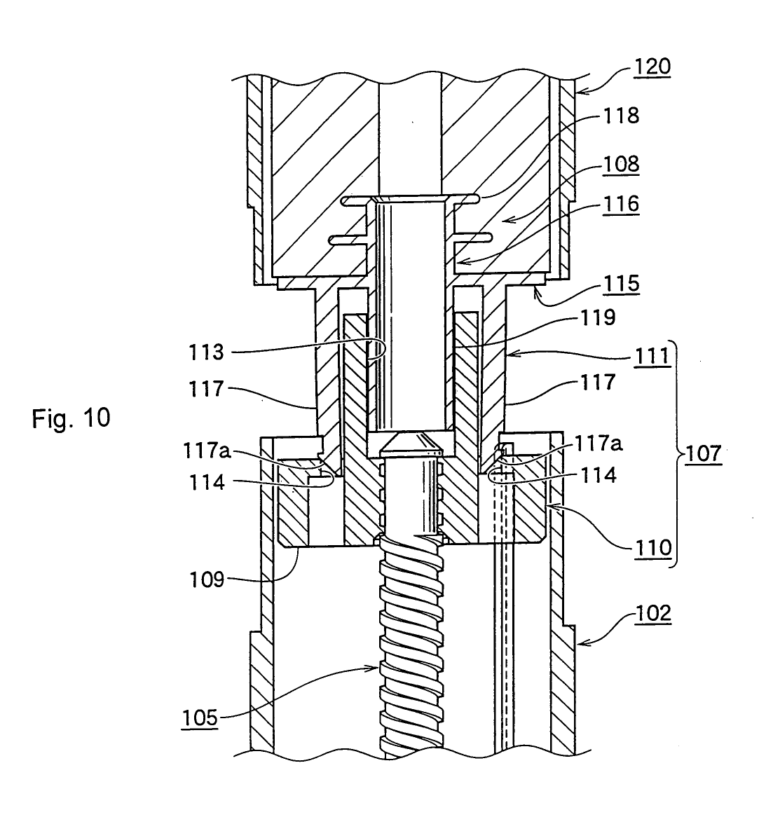

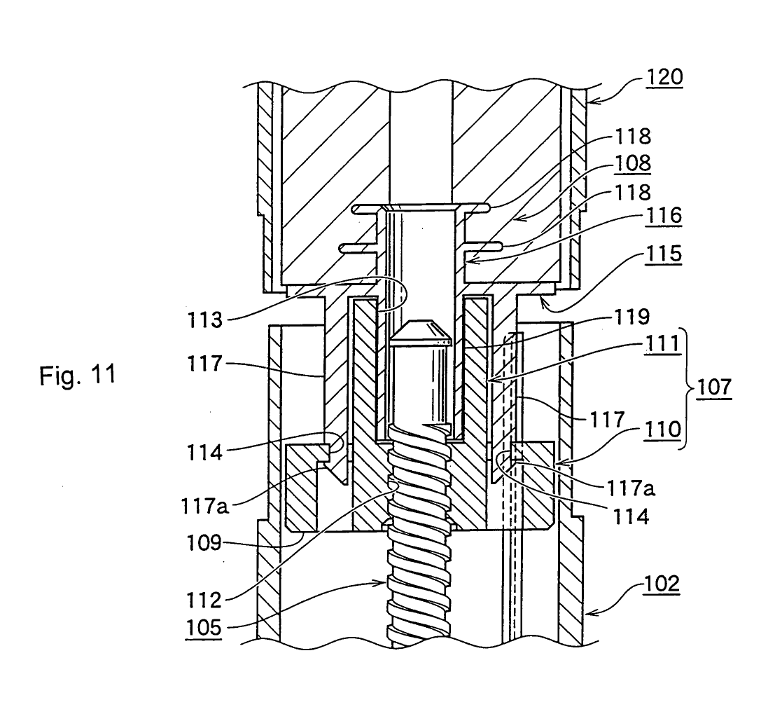

FIG. 7 is a central longitudinal sectional view showing a state where solid paste is accommodated in the solid paste dispenser of the invention, with a part thereof broken away, FIG. 8 is a central longitudinal sectional view showing a cartridge case which accommodates solid paste for replacement, with a part thereof broken away, FIG. 9 is an enlarged perspective view of main parts when replacing work of solid paste is performed, and FIGS. 10 and 11 are enlarged longitudinal sectional views of main parts for explaining the replacing work.

As shown in FIG. 7, the solid paste dispenser 101, similarly to a publicly-known solid paste dispenser, is adapted to protrude a front end 104a of solid paste 104 from a front end opening 102a and retract the front end opening by the rotation of a tail wheel 103 which is mounted to one end of a main body cylinder 102.

A screw rod 105 is integrally formed with the tail wheel 103, and a slider 107 is adapted to ascend and descend within the main body cylinder 102 with the rotation of the tail wheel 103 by threaded engagement with the screw rod 105 and by guidance by a guide ridge 106 which is axially provided on an inner peripheral surface of the main body cylinder 102.

A solid paste receiving member 108 which retains the solid paste 104 is detachably engaged with the slider 107. By rotating the tail wheel 103, the front end 104a of the solid paste 104 can be protruded from and retracted into the front end opening 102a of the main body cylinder 102.

As shown in FIGS. 9 and 11, the slider 107 is composed of a slider base 110 at a rear peripheral edge of which an edge frame 109 is provided and a slider cylinder 111 which is provided in the center of the slider base 110 so as to protrude axially forward.

The slider cylinder 111 has a part 112 to be screwed to the screw rod 105, at a rear inner peripheral edge thereof, and the slider cylinder is formed with a concave fitted part 113 by forming the section of a cylinder hole 113 at a front part thereof in a substantially square shape.

Four engaging holes 114 are bored in the slider base 110 at regular intervals around the slider cylinder 111 as engaging parts.

Meanwhile, the solid paste receiving member 108 is formed by an axial paste receiving cylinder 116 which is provided in the center of a disk-like paste receiving base 115 so as to protrude forward and rearward, and four locking pieces 117 which are provided on a rear face of the paste receiving base 115 so as to protrude rearward at regular intervals in the peripheral direction. An outer peripheral surface of a front part of the paste receiving cylinder 116 is provided with a flange-like retaining part 118 for retaining the solid paste 104, and a rear part of the paste receiving cylinder 116 is formed with a prismatic fitting part 119 as a protruding fitting part.

The locking pieces 117 are adapted to be capable of being deformed elastically, and rear ends of the locking pieces 117 are provided with outward locking claws 117a, respectively.

As shown in FIG. 8, the solid paste 104 accommodated in a cartridge case 120 is retained by the solid paste receiving member 108.

Next, the work when the solid paste 104 is replaced will be described.

First, as shown in FIG. 9, a cap 121 (refer to FIG. 7) of the main body cylinder 102 is detached, and the tail wheel 103 is rotated to partially protrude the slider 107 from the front end opening 102a of the main body cylinder 102.

Next, a cap 122 of the cartridge case 120 which accommodates the solid paste 104 for replacement shown in FIG. 8 is detached. Then, as shown in FIG. 9, the solid paste receiving member 108 is caused to approach the slider 107 with the cartridge case 120 upside down, and as shown in FIG. 10, the prismatic fitting part 119 in the solid paste receiving member 108 is fitted into the cylinder hole (concave fitting part 113) of the slider cylinder 111 in the slider 107.

Since the prismatic fitting part 119 and the concave fitting part 113 are adapted to be visually recognized from outside, the prismatic fitting part 119 can be easily fitted into the concave fitting part 113, and this fitting allows a proper rotational position of the solid paste receiving member 108 with respect to the slider 107 to be automatically adjusted.

Next, by further pushing the cartridge case 120 rearward to push in the solid paste receiving member 108, the locking claws 117a provided at the rear ends of the locking pieces 117 in the solid paste receiving member 108 are abutted on inner peripheral edges of the engaging holes 114 in the slider 107, and the locking pieces 117 are elastically deformed inwardly.

Next, by further pushing in the solid paste receiving member 108 to move the solid paste receiving member rearward relative to the slider 107, as shown in FIG. 11, the locking claws 117a are locked to the engaging holes 114, respectively. This locking allows the solid paste 104 to be indirectly mounted to the slider 107 with the solid paste receiving member 108 therebetween.

Next, the tail wheel 103 is rotated to draw the solid paste 104 along with the solid paste receiving member 108 and the slider 107 into the main body cylinder 102, whereby the replacing work of the solid paste 104 for replacement is completed.

When the replaced solid paste 104 is worn, and it is replaced with a new solid paste 104, the tail wheel 103 is rotated to protrude the solid paste receiving member 108 from the front end opening 102a of the main body cylinder 102, thereby releasing the locking between the locking claws 117a in the solid paste receiving member 108 and the engaging holes 114, so that the worn solid paste 104 along with the solid paste receiving member 108 can be easily detached from the slider 107. The worn solid paste 104 may be disposed along with the solid paste receiving member 108, or may be disposed after being separated from the solid paste receiving member 108.

Next, a new solid paste 104 may be replaced similarly to the above.

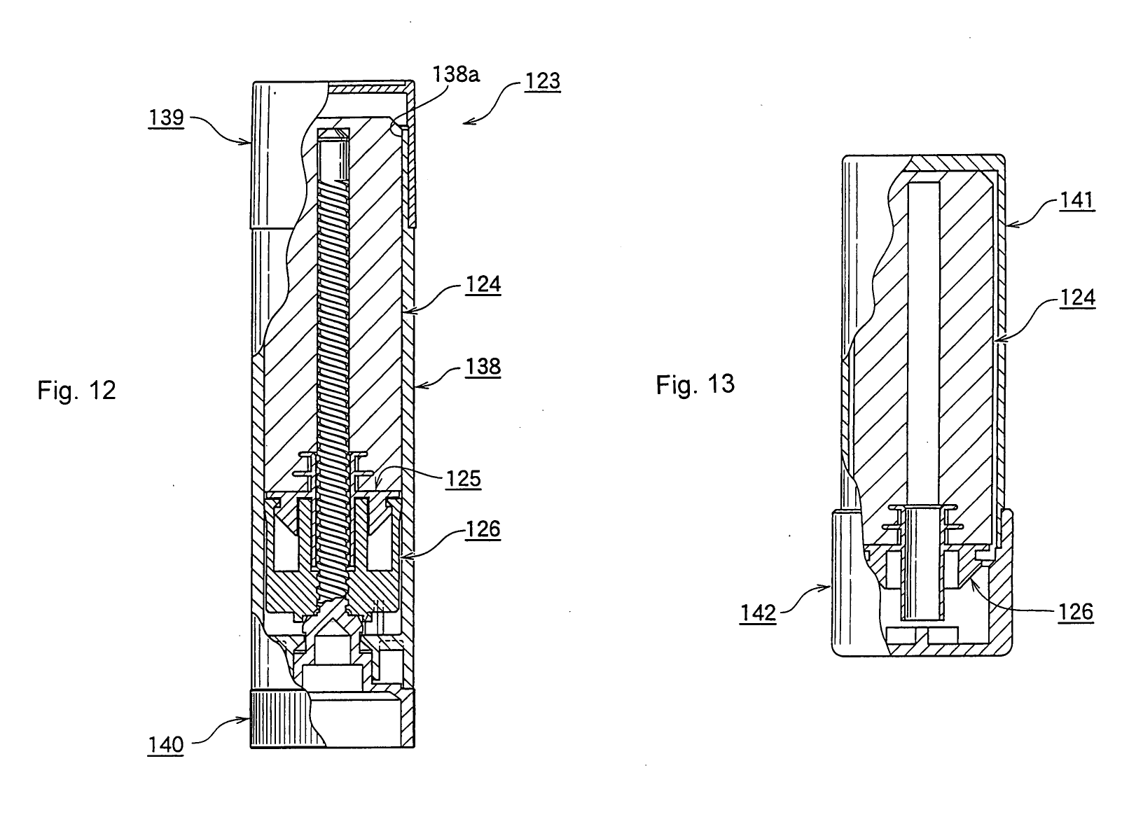

FIGS. 12 to 16 are views relating to a solid paste dispenser 123 of a third embodiment of the invention, and views corresponding to FIGS. 7 to 11, respectively, of the second embodiment.

As shown in FIG. 12, solid paste 124 is indirectly mounted to a slider 126 by means of a solid paste receiving member 125, similarly to the first embodiment.

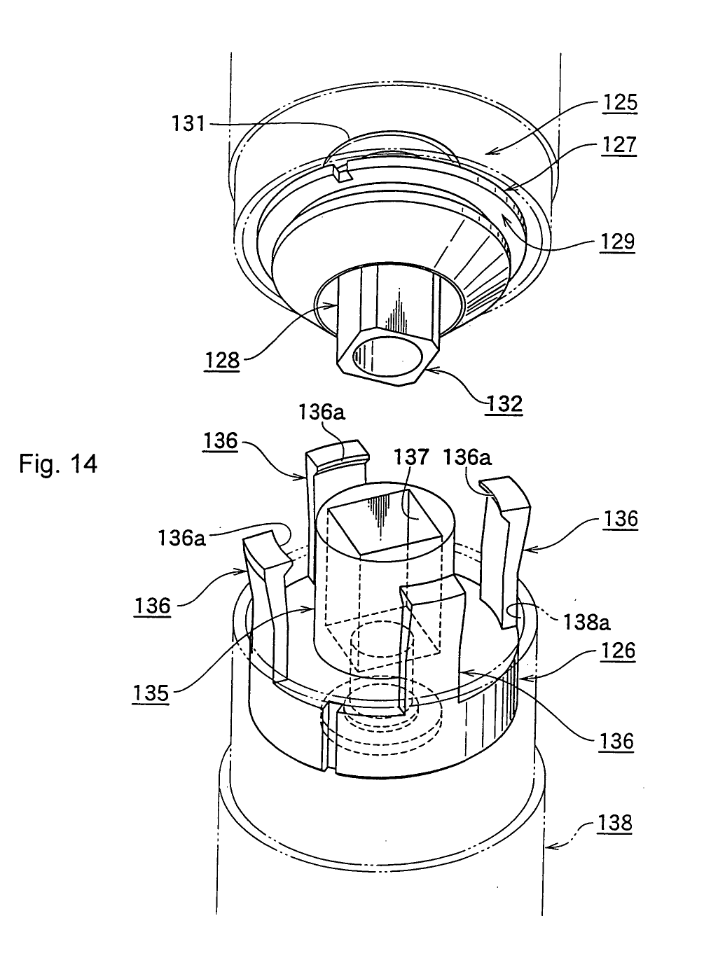

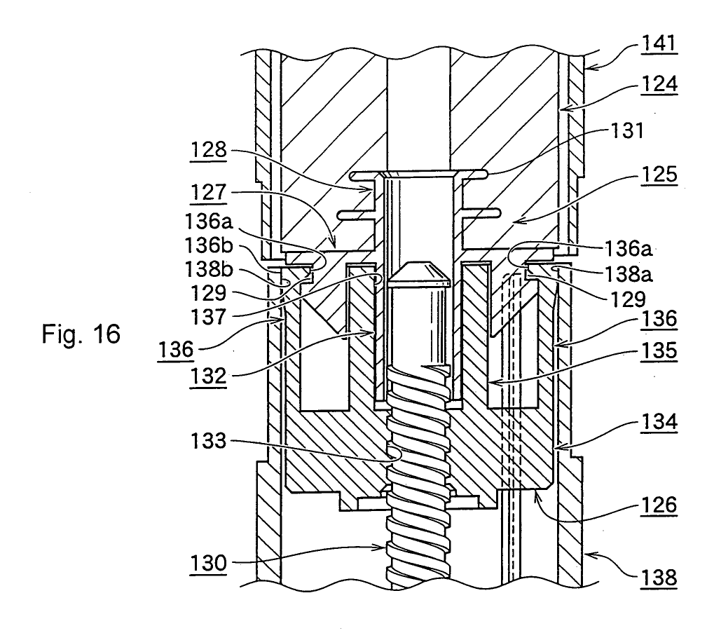

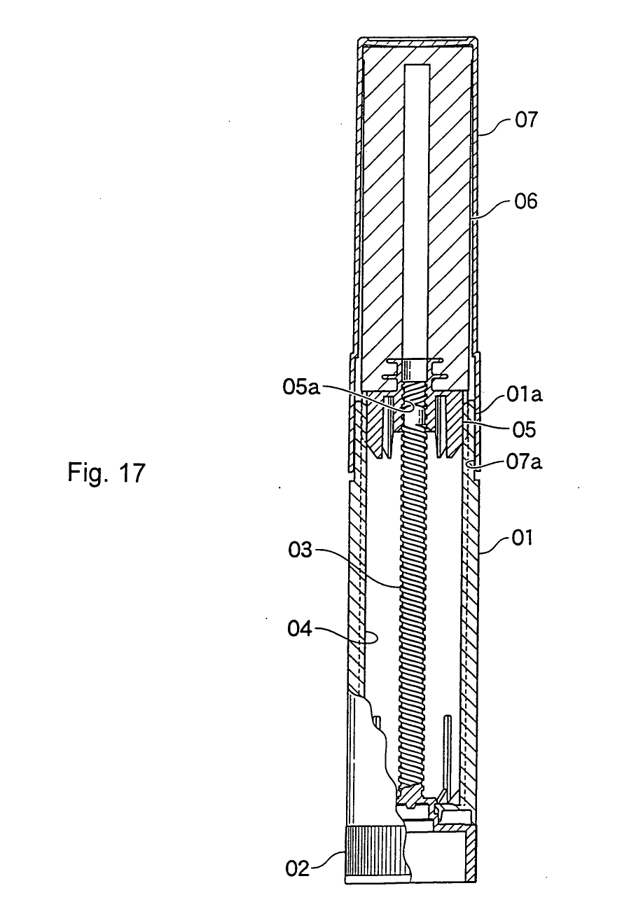

As shown in FIGS. 14 and 16, the solid paste receiving member 125 is composed of a paste receiving base 127, and a paste receiving cylinder 128 which is provided in the center of the paste receiving base so as to protrude forward and rearward. A rear face of the paste receiving base 127 is formed in the shape of a truncated cone whose diameter is reduced rearward, and a lateral peripheral surface of the truncated cone is provided with a peripheral annular groove engaging part 129.

A cylinder interior 128a of the paste receiving cylinder 128 becomes an insertion hole of a screw rod 130. An outer peripheral surface of a front part of the paste receiving cylinder 128 is provided with a flange-like retaining part 131 for retaining the solid paste 124, and a rear part of the paste receiving cylinder 128 is formed with a prismatic fitting part 132.

Meanwhile, the slider 126 is composed of a slider base 134 having a part 133 to be screwed to the screw rod 130, at the center thereof, a slider cylinder 135 which is axially provided in the front center thereof, and four locking pieces 136 which are provided at regular intervals on a front peripheral edge of the slider base 134 so as to face the front.

The interior of the slider cylinder 135 is formed with a concave fitting part 137 into which the prismatic fitting part 132 in the solid paste receiving member 125 is to be fitted.

Front ends of the locking pieces 136 are provided with inward locking claws 136a.

Next, the work when the solid paste 124 is replaced will be described.

First, as shown in FIG. 14, a cap 139 (refer to FIG. 12) of the main body cylinder 138 is detached, and the tail wheel 140 is rotated to partially protrude the slider 126 from the front end opening 138a of the main body cylinder 138.

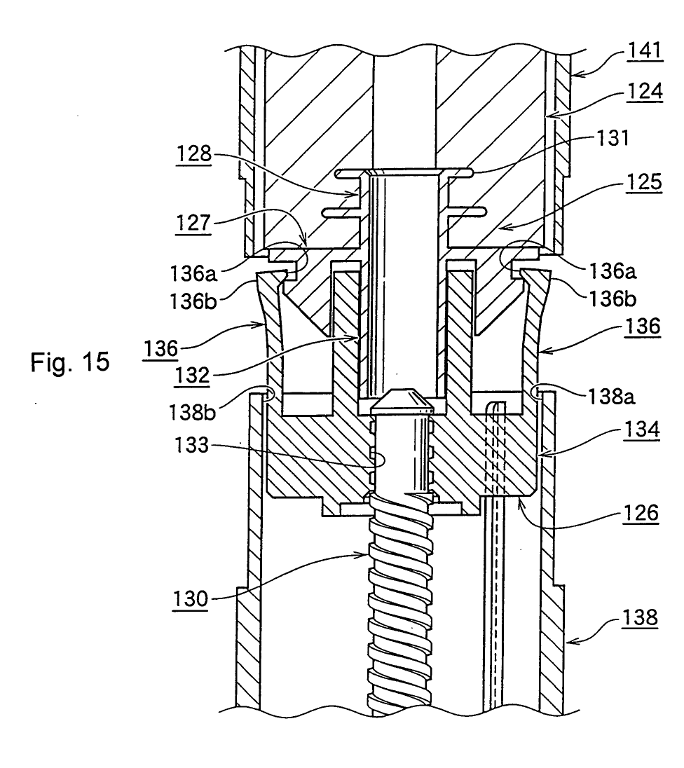

Next, a cap 142 of a cartridge case 141 which accommodates the solid paste 124 for replacement shown in FIG. 13 is detached. Then, as shown in FIG. 14, the solid paste receiving member 125 is caused to approach the slider 126 with the cartridge case 141 upside down, and as shown in FIG. 15, the prismatic fitting part 132 in the solid paste receiving member 125 is fitted into the cylinder hole (concave fitted part 137) of the slider cylinder 135 in the slider 126.

Since the prismatic fitting part 132 and the concave fitting part 137 are adapted to be visually recognized from outside, the prismatic fitting part 132 can be easily fitted into the concave fitted part 137, and this fitting allows a proper rotational position of the solid paste receiving member 125 with respect to the slider 126 to be automatically adjusted.

Next, by further pushing the cartridge case 141 rearward to push in the solid paste receiving member 125, the locking claws 136a provided at the front ends of the locking pieces 136 in the slider 126 are locked into the annular groove engaging part 129 in the solid paste receiving member 125.

Next, by further pushing in the solid paste receiving member 125 to move the solid paste receiving member rearward relative to the slider 126, as shown in FIG. 16, outside surfaces 136b of front ends of the locking pieces 136 are abutted on an inner peripheral surface 138b in the front end opening 138a of the main body cylinder 138, whereby the locking claws 136a are pushed inwardly and positively locked to the annular groove engaging part 129 in the solid paste receiving member 125.

As such, the outside surfaces 136b of the front ends of the locking pieces 136 are formed in advance such that they are located further outside than the inner peripheral surface 138b in the front end opening 138a of the main body cylinder 138 while the locking pieces 136 are outside the main body cylinder 138. As a result, the locking claws 136a can be positively and securely to locked to the annular groove engaging part 129 by drawing the locking pieces 136 into the main body cylinder 138.

Next, the tail wheel 140 is rotated to draw the solid paste 124 along with the solid paste receiving member 125 and the slider 126 into the main body cylinder 138, whereby the replacing work of the solid paste 124 for replacement is completed.

The above description of preferred embodiments has been given by way of example. From the disclosure given, those skilled in the art will not only understand the present invention and the attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A solid paste dispenser comprising a slider which is in threaded engagement with a screw rod formed integrally with a tail wheel mounted to an end of a main body cylinder for rotating the screw rod within the main body cylinder for ascending and descending said slider within the main body cylinder by rotating the tail wheel, a guide means axially provided on an inner peripheral surface of the main body cylinder for guiding the slider, and a columnar solid paste mounted to the slider for protruding a front end of the solid paste from the main body cylinder and retracting it into the main body cylinder,
wherein the solid paste is indirectly mounted to the slider by retaining a rear end of the solid paste in a solid paste receiving member, said solid paste receiving member engaging said slider in detachable manner.

2. The solid paste dispenser according to claim 1, wherein a locking claw is provided in any one of both the solid paste receiving member and the slider, and an engaging part is provided in the other one, at least one of the locking claw and the engaging part is adapted to be elastically deformed, said elastic deformation is utilized for detachably engaging the solid paste receiving member with the slider.

3. The solid paste dispenser according to claim 1, wherein a guide part for rotating the solid paste receiving member relative to the slider is provided in order to lock the locking claw provided in any one of the solid paste receiving member and the slider to the engaging part provided in the other one.

4. The solid paste dispenser according to claim 3, wherein the slider is formed from a guide cylinder having a part to be screwed to the screw rod at an inner peripheral surface thereof, and an engaging part provided at a rear end of the guide cylinder, and an outer peripheral surface of the guide cylinder is provided with a rearward converging guide groove, and
wherein the solid paste receiving member is provided with a guide locking piece, the guide groove and the guide locking piece constitute the guide part, and the guide locking piece is guided by the guide groove to rotate the solid paste receiving member relative to the slider so that the locking piece provided in the solid paste receiving member is locked to the engaging part provided in the slider.

5. The solid paste dispenser according to claim 4, wherein the slider is formed from a guide cylinder having a part to be screwed to the screw rod at an inner peripheral surface thereof, and having a rearward converging guide groove at an outer peripheral surface thereof, and an outer cylinder coaxially provided at a rear end of the guide cylinder, having a larger diameter than the guide cylinder, and having an engaging part, and
wherein the solid paste receiving member is formed from a guided cylinder having a solid paste retaining part at a front end thereof, fitted on the guide cylinder in the slider, and having a locking part, and an inner peripheral surface of the guided cylinder is provided with a guide locking piece such that the guide locking piece is guided by the guide groove of the slider.

6. The solid paste dispenser according to claim 5, wherein a rear end of the rearward converging guide groove provided at the outer peripheral surface of the guide cylinder in the slider is provided with an axial auxiliary guide groove continuously with the guide groove.

7. A solid paste dispenser comprising a slider which is in threaded engagement with a screw rod formed integrally with a tail wheel mounted to an end of a main body cylinder for rotating the screw rod within the main body cylinder for ascending and descending said slider within the main body cylinder by rotating the tail wheel, a guide means axially provided on an inner peripheral surface of the main body cylinder for guiding the slider, and a columnar solid paste mounted to the slider for protruding a front end of the solid paste from the main body cylinder and retracting it into the main body cylinder,
wherein the solid paste is indirectly mounted to the slider by retaining a rear end of the solid paste in a solid paste receiving member, said solid paste receiving member engaging said slider in detachable manner, and
wherein, a positioning means is provided for determining the rotational position of the solid paste receiving member with respect to the slider when the solid paste receiving member is engaged with the slider, said positioning means comprising a protruding fitting part in any one of facing surfaces between the solid paste receiving member and the slider, and a concave fitting part in the other one such that a fitting between the protruding fitting part and the concave fitting part can visually be recognized from outside, thereby allowing rotational positioning by virtue of the fitting.

8. The solid paste dispenser according to claim 7, wherein a locking claw is provided in any one of both the solid paste receiving member and the slider, and an engaging part is provided in the other one, at least one of the locking claw and the engaging part is adapted to be elastically deformed, said elastic deformation is utilized for detachably engaging the solid paste receiving member with the slider.

9. The solid paste dispenser according to claim 7, wherein the solid paste receiving member comprises an axial paste receiving cylinder within which an insertion hole for the screw rod is formed, in the center of a paste receiving base so as to protrude forward and rearward, a solid paste retaining part at a front part of the paste receiving cylinder, forming a prismatic fitting part at a rear part of the paste receiving cylinder, and a locking piece having a locking claw at a rear end thereof, on a rear surface of the paste receiving base so as to protrude therefrom, and
wherein the slider comprises an axial slider cylinder having a part to be screwed with the screw rod on an inner peripheral surface of a rear part thereof and having a concave fitting part at a front part thereof, in the center of a base of the slider so as to protrude forward, and providing an engaging part to be locked to the locking claw, in the slider base.

10. The solid paste dispenser according to claim 7, wherein the solid paste receiving member comprises a paste receiving cylinder within which an insertion hole for the screw rod is formed, in the center of a paste receiving base so as to protrude forward and rearward, a solid paste retaining part at a front part of the paste receiving cylinder, forming a prismatic fitting part at a rear part of the paste receiving cylinder, a rear surface of the paste receiving base being formed in the shape of a truncated cone whose diameter is reduced rearward, and a peripheral annular groove engaging part on a lateral peripheral surface of the truncate cone, and
wherein the slider comprises a slider cylinder having a concave fitted part, in a front center of a slider base having a part to be screwed with the screw rod in the center thereof, and said slider base having a forward locking piece having a locking claw to be locked to the annular groove engaging part at a front end thereof.

11. The solid paste dispenser according to claim 9, wherein an outer peripheral surface of a front part of the paste receiving cylinder is provided with a flange-like retaining part for retaining the solid paste.
